(19) United States
(12) Patent Application Publication
(10) Pub. No.: US 2003/0171047 A1
(43) Pub. Date: Sep. 11, 2003

(54) Method and systems for exterior insulation of a structure

(75) Inventors: Luis Calvo, Bay Shore, NY (US); Samsoodeen Khan, Brentwood, NY (US); Glenn Pergament, Plainview, NY (US); Steve Noskin, Dix Hills, NY (US)

Correspondence Address: DARBY & DARBY P.C., 805 Third Avenue, New York, NY, 10022, US

(73) Assignee: Vitricon, Inc.

(21) Appl. No.: 10/382,272

(22) Filed: Mar. 5, 2003

Related U.S. Application Data
(60) Provisional application No. 60/362,109, filed on Mar. 5, 2002.

(51) Int. Cl. B32B 5/18; B32B 5/22; B05D 1/36; B05D 7/00

(52) U.S. Cl. 442/76; 427/402

(57) ABSTRACT

An insulation coating system for insulating a structure comprised of three flexible moisture barrier coatings; (1) a first coating comprising an elastomeric acrylic resin and an antimicrobial, (2) a second coating comprising an acrylic resin, a cement and fibers; and (3) a third coating comprising an elastomeric acrylic resin, a water repellant, an aggregate and an antimicrobial. The coatings adhere to the structure with an insubstantial amount of interfacial voids, and prevent a substantial amount of moisture from contacting the surface of the substrate.

This application claims the benefit under 35 U.S.C. §119(e) of U.S. Provisional Application No. 60/362,109, filed Mar. 5, 2002, which is hereby incorporated by reference.

### FIELD OF THE INVENTION

This invention is directed to exterior insulation coating for a structure. More specifically, the present invention relates to a series of coatings that bond together and leave an insubstantial amount of interfacial voids, thus preventing a substantial amount of moisture from contacting the surface of the structure.

### BACKGROUND OF THE INVENTION

The practice of insulating structures is well known. Typical methods of insulating an exterior of a structure involve affixing insulating material to the surface of the structure. The insulating material is then reinforced with a base coat and fiber mesh, and the mesh is covered with a finish coat to seal the insulation from the elements. This process, though widely used, has some disadvantages. In humid climates, moisture may be trapped between the substrate and the insulating material. This entrapped moisture then acts as a medium for the growth of micro-organisms, including microorganisms which have been found to be harmful to humans. This entrapped moisture can also damage the structure. Since the moisture cannot escape, its vapor pressure may increase with the changes in temperature and this pressure can erode the surface of the structure. The moisture can enter the system through the joints between the insulating material and joints exposed at window and door cut-outs once the caulking protecting those seams fails. Once entrapped, the moisture cannot escape because the system is designed not to “breathe,” not allowing for the transfer of moisture out of the system.

More recent methods of insulating structures allow for water drainage passages between the substrate and the insulating foam. However, the use of water drainage passages also has disadvantages, especially in humid climates. The passageways are prone to blockage and debris can enter the drainage passageways and diminish their effectiveness for removing moisture. This allows moisture to accumulate between the substrate and the insulating material. Due to the increased size of the passageways, more moisture is allowed to accumulate, and more microorganisms can flourish and larger vapor pressures can be created.

### SUMMARY OF THE INVENTION

It is the foregoing and various other drawbacks of the prior art which the present invention seeks to overcome by providing an insulation coating system and method that can insulate a structure and prevent moisture accumulation. The insulation coating system is comprised of three separate, flexible moisture barrier coatings. The first flexible moisture barrier coating, or “primer”, is comprised of an elastomeric acrylic resin and an antimicrobial. The first coating can adhere to the surface of the structure with an insubstantial amount of interfacial voids. Next, a second flexible moisture barrier coating, or “cementitious” coating, is applied in contact with the first coating. The second coating comprises an acrylic resin, a cement and fibers. Then, a third flexible moisture barrier coating, a “finish” coating, is applied. The third coating comprises an elastomeric acrylic resin, an aggregate, a water repellant and an antimicrobial.

The insulation coating system of the present invention overcomes the shortcomings of the previous systems and methods. The bonding between the coatings themselves and the substrate prevents a substantial amount of moisture from entering the surface. Further, all three coatings can be “breathable,” and allow moisture to escape. The coatings can also contain an antimicrobial, which kills or inhibits the growth of any microorganisms, including microorganisms that may damage the structure or are harmful to humans.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a cross-sectional view generally illustrating a prior art exterior insulation finishing system;

FIG. 2 is a cross-sectional view generally illustrating a prior art exterior insulation finishing system with a drainage passage;

FIG. 3 is a flow diagram illustrating one embodiment of the invention of insulating a structure; and

FIG. 4 is a cross-sectional view illustrating the coatings of the current invention as applied to the substrate.

### DETAILED DESCRIPTION OF THE INVENTION

Definitions

The following definitions of the general terms are used in the present specification and apply irrespective of whether the terms appear as such or in combination.

As used herein, the term “structure” means a building, wall, shelter, or other edifice, whether completed or under construction. Structures contemplated for use in the invention may be temporary or permanent, and may be constructed of any building material.

As used herein, the term “interfacial voids” means spaces or voids formed between the common boundary of two bodies, spaces, surfaces or phases.

As used herein, the term “microorganisms” includes organisms too small to be seen with the naked eye, and include mold, yeast, fungus and bacteria.

As used herein, the terms “biocide” and “antimicrobial agent” are used interchangeably, and mean an agent capable of killing or retarding the growth of a microorganism.

As used herein, the term “bactericidal agent” and “antibacterial agent” are used interchangeably, and mean an agent capable of killing or retarding the growth of bacteria.

As used herein, the term “fungicidal agent” and “antifungal agent” are used interchangeably, and mean an agent capable of killing or retarding the growth of fungi.

As used herein, the term “moisture barrier” means a material that blocks or is intended to block the passage of a liquid, typically water, in the form of precipitation or condensation. Moisture barrier materials contemplated for use in the invention are permeable to liquid vapors.

Methods of Applying Coatings

Methods of applying insulating coatings to structures are well known to those in the construction industry. Typically, a surface is prepared before a coating is applied. Preparation includes filling any chips or large voids, removing any excess material or loose particles, and smoothing the surface of any projections, including steel or tie rods projecting through poured or pre-cast concrete. The surface should also be free of any chemical agents, including concrete curing compounds or form release agents, such as silicones, oils or similar materials, grease, or paint. Lastly, the surface should be clean, dry and above a specified surface temperature depending on the type of coating.

After the surface is prepared, coatings can be applied in a number of ways. Thin coatings can be applied by brushing, rolling, or spraying the coating onto the surface or onto a preexisting coating. Preexisting coatings typically should dry for a minimum of 24 hours, and should be kept dry and above a minimum air/surface temperature for the entire period. Thicker coatings can be applied by spraying or troweling the coating onto the surface or onto a preexisting coating. These coatings should also dry under specific parameters.

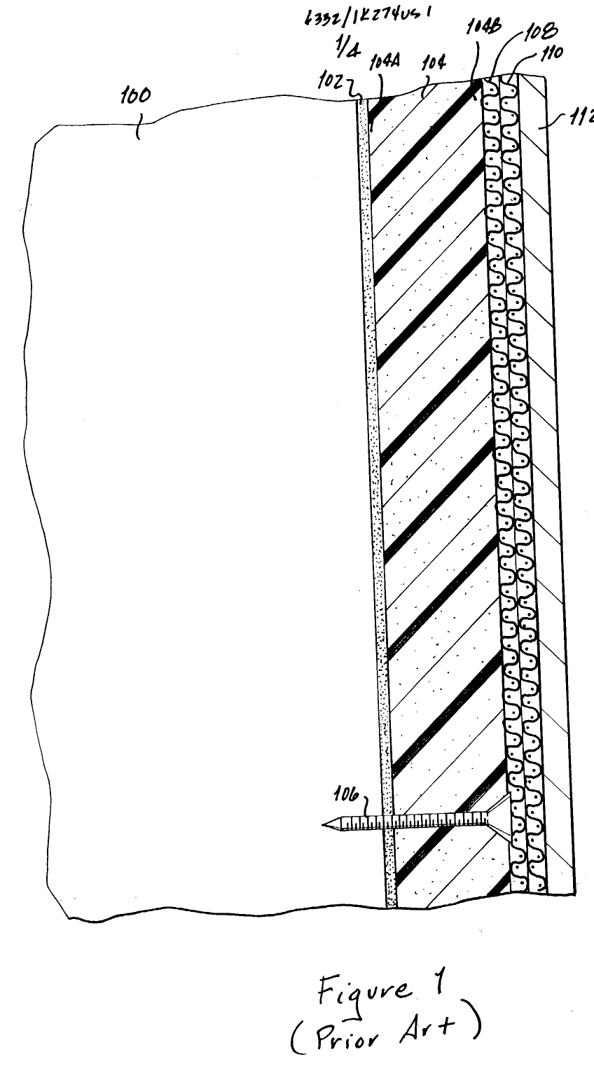

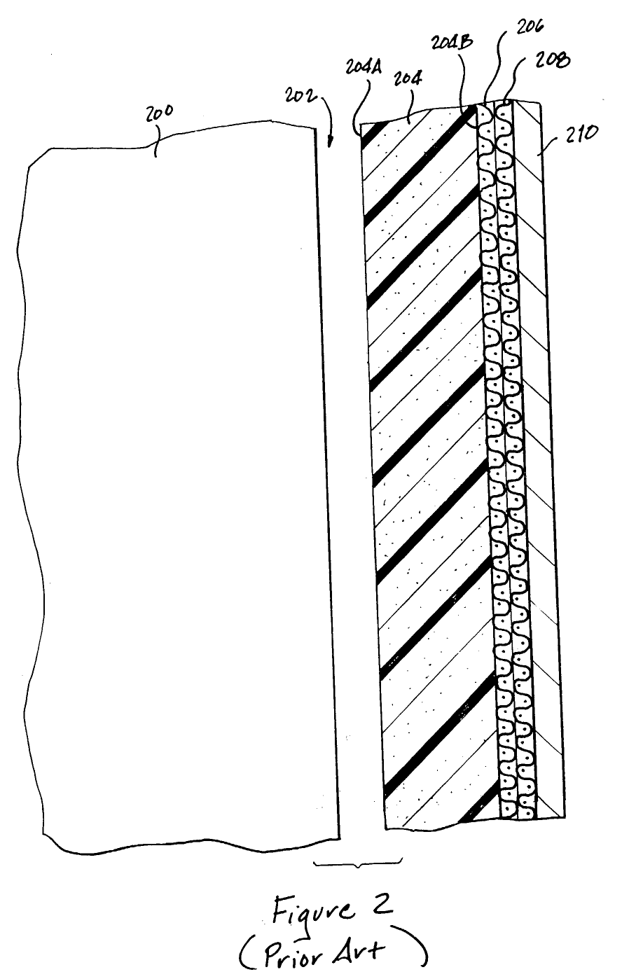

Referring now to FIGS. 1 and 2, cross-sections of prior art exterior insulation systems are illustrated. FIG. 1 illustrates a traditional exterior insulation system without a drainage passage. A substrate 100 is first coated with an adhesive 102. A precut board of insulating material 104 has a substrate side 104A and a mesh side 104B. Substrate side 104A of insulating material 104 is adhered to substrate 100 by adhesive 102. A mechanical fastener 106 (for example, a screw) can be included to also fasten insulating material 104 to substrate 100. A mesh base coat 108 is then applied to mesh side 104B of insulating material 104. Base coat 108 is applied, typically to a thickness up to 0.375 inches. After base coat 108 is applied, a reinforcing mesh 110 is applied on top of the base coat. Lastly, a finish coat 112 is applied over reinforcing mesh 110 and allowed to dry to complete the insulation.

FIG. 2 illustrates a prior art insulation system with a drainage passage. A substrate 200 is first coated with an adhesive (not illustrated). A precut board of insulating material 204 has a substrate side 204A and a mesh side 204B. Substrate side 204A of insulating material 204 is adhered to substrate 200 by the adhesive. However, insulation material 204 is adhered in a manner such that water drainage passageways 202 are formed between substrate 200 and insulating material 104. A mesh base coat 206 is then applied to mesh side 204B of insulating material 204. Base coat 206 is applied, typically to a thickness up to 0.375 inches. After base coat 206 is applied, a reinforcing mesh 208 is applied on top of it. Lastly, a finish coat 210 is applied over reinforcing mesh 208 and allowed to dry to complete the insulation.

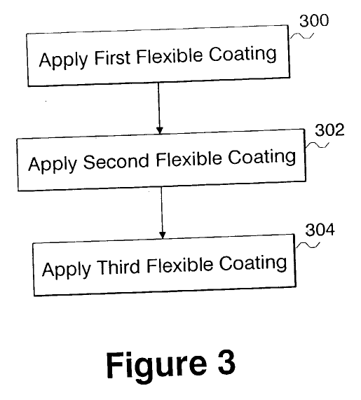

FIG. 3 illustrates a method for insulating a structure in accordance with the present invention. First, the surface of the structure (e.g., masonry block, concrete, plaster or stucco) is prepared. Then, a first flexible moisture barrier coating or “primer” is applied to the surface of the structure (step 300). The first coating should be applied up to about 32 mils to about 48 mils thick, typically through 2 coats up to a maximum of about 16 mils to about 24 mils each. Once applied, the first coating adheres to the surface with an insubstantial amount of interfacial voids. The first coating is comprised of an elastomeric acrylic resin and an antimicrobial. Next, a second flexible moisture barrier coating is applied on top of the first coating (step 302). The second coating should be applied only up to about 0.5 inches (500 mils) thick. The second coating is comprised of an acrylic resin, a cement and fibers.

Lastly, a third flexible moisture barrier coating is applied on the second coating (step 304). The third coating should be applied up to about 16 mils to about 24 mils thick. The third coating is comprised of an elastomeric acrylic resin, an aggregate, a water repellant and an antimicrobial, and may optimally also comprise a coloring agent. This agent will cause the third coating to be pigmented and thus the exterior of the structure will be colored to match the third coating.

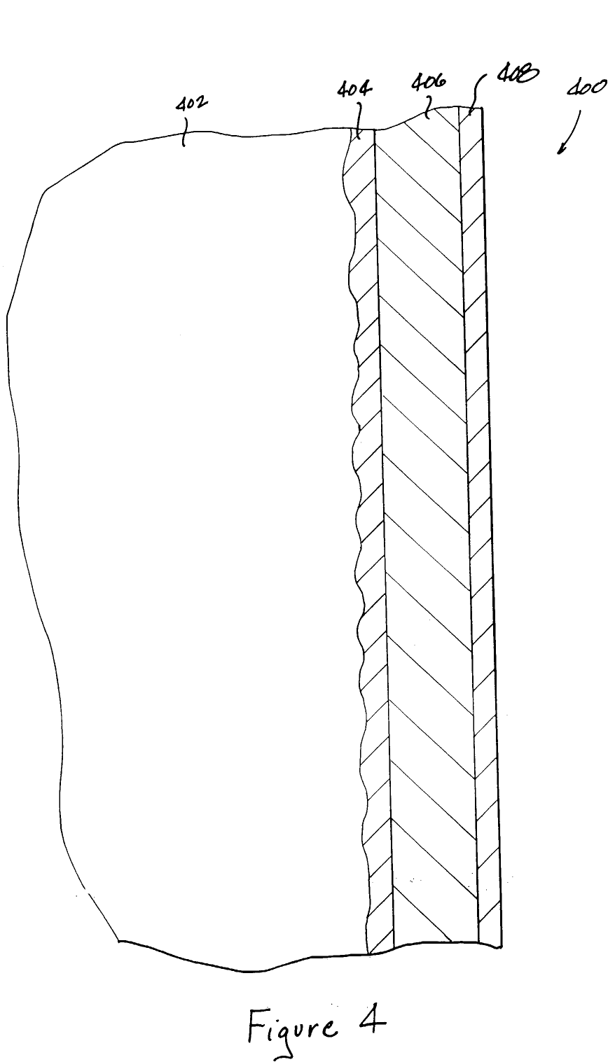

FIG. 4 illustrates a cross-section of the current insulating system 400 as applied to a substrate 402. Substrate 402 is coated with a first flexible moisture barrier coating 404. This coating adheres to substrate 402 and fills in a substantial amount of interfacial voids. Next, a second flexible moisture barrier coating 406 is applied on top of first coating 404. Lastly, a third flexible moisture barrier coating 408 is applied on top of second coating 406.

Once all three coatings are applied, the system can be effective to prevent a substantial amount of moisture from entering the surface, and also pass vapors away from the surface. The coating system acts as a moisture barrier because the third coating contains a water repellant. This keeps precipitation and condensation from entering the system.

Also, contrary to the prior art systems, the current invention does not have joints or seams. Even though the coatings are designed to prevent moisture from entering the system, the coatings are designed to let moisture vapor out.

First Coating

The first coating, or “primer,” is applied directly in contact with the structure to be insulated. The first coating is a breathable, water based coating formed from an elastomeric acrylic resin base, and includes one or more antimicrobials. The first coating may also optionally contain water, fillers, defoamers, binders, dispersants, pigments and colorants, and other additives commonly used in forming insulation coatings.

Exemplary first coatings may contain from about 0 to about 40% by weight, preferably between about 15 to about 30%, water; up to about 5% by weight, preferably up to about 0.15%, potassium tripolyphosphates (KTPP); up to about 5% by weight, preferably up to about 0.2%, antimicrobials; up to about 2% by weight, preferably up to about 0.5%, defoamer; up to about 2% by weight, preferably up to about 0.45%, dispersant; up to about 10% by weight, preferably about 4 to about 7%, pigments and colorants; up to about 60% by weight, preferably about 20 to about 40% filler; up to about 5% by weight, preferably about 1 to about 3%, zinc oxide; up to about 60% by weight, preferably about 20 to about 40%, binder; and up to about 5%, preferably up to about 0.1%, pH control agent.

The first coating may be formed by mixing the various components, through use of any industrial mixer. Certain of the ingredients may require grinding.

Suitable first flexible moisture barrier coatings may have the properties of

TABLE 1
Properties of First Coating

| Property | Testing Method | Range |
|---|---|---|
| In-Service Temperature | ASTMD-822 | −20° F. to 20° F. |
| Permeability | ASTME-96-80 | 4.8 perms at 29 mils |
| Mildew Resistance | Mil Std-810 | No Mildew Growth |
| Elongation | ASTMD-412 | 350-400% |
| Tensile Strength | ASTMD-412 | 150-200 psi |
| Viscosity | ASTMD-2393 | 100-104 K.U. |
| Low Temperature Flexibility | ASTMD-412 | passes 180° bend at |
| | | −20° F. |
| Flame Spread (F.R. | UL 790 | Class A |
| Version) | | |
| Freeze/Thaw | | passes 5 cycles |
| Flash Point | | None |
| Solids by Weight | | 69.9% |
| Solids by Volume | | 60.0% |
| Weight per Gallon | | 12.3 lbs/gallon |

Second Coating

The second coating, a “base” or “cementitious” coating, is applied in contact with the first coating. The second coating is a cementitious and elastomeric based coating, which can be applied in thick layers and can be used to “build” up the existing surface (‘high build’), and allowing for the passage of moisture vapors. The second coating also contains one or more antimicrobials, and may optionally contain fibers, water, fillers, defoamers, binders, dispersants, pigments and colorants, and other additives commonly used in forming insulation coatings.

Exemplary second coatings may be formed from up to about 90%, preferably about 35 to about 55%, aqueous acrylic emulsion; up to about 5% by weight, preferably about 0.5 to about 2.5%, fibers; up to about 5% by weight, preferably up to about 0.2%, minerals; up to about 5% by weight, preferably up to about 0.3%, defoamer; up to about 5% by weight, preferably up to about 0.4%, cement dispersant; up to about 90% by weight, preferably about 35 to about 55%, filler; up to about 5% by weight, preferably about 0.4%, thickening agent; up to about 5% by weight, preferably, about 0.01 to about 0.2%, solvent; up to about 5% by weight, preferably up to about 0.3%, pH control agent; up to about 10% by weight, preferably about 4 to about 6%, water; and up to about 5% by weight, preferably, about 0.10 to about 0.80%, antimicrobials. The composition described above is mixed with cement to form the final coating. Suitable ratios range from about 5 parts composition to about 2.0 parts cement, to about 2.0 parts composition to about 0.5 parts cement. A preferred ratio is approximately 1:1, i.e. approximately 1 part composition to approximately 1 part cement.

Suitable second coatings may have the properties described in Table 2.

TABLE 2
Properties of Second Coating

| Property | Testing Method | Range |
|---|---|---|
| Fire Resistance | ASTME-84-814 | Flame Spread - 5 |
| | Tunnel Test | Smoke developed - 0 |
| Wind Load | ASTME-330-70 | 100 psf mm. Loads with no |
| | | delamination |
| Water Vapor | ASTMC-355 | Permeance - 4.8 perms |
| Transmission | | Permeability - 1.8″ perms |
| Tensile Bond | ASTMC-297 | 1100 psi min on ½″ water |
| | | resistant gypsum sheathing |
| Penetration of Moisture | ASTMC-355 | Less then 30 perms |
| Barrier | | |
| Accelerated Weathering | ASTMG-23 | Passes 2000 hours |
| Mildew Resistance | Mil Std-810 | No Mildew Growth |
| Elongation | ASTMD-412 | 15-20% |

Third Coating

The third, or “outer” or “finish” coating, which is applied in contact with the second coating, is an elastomeric based coating which contains one or more antimicrobials and a water repellant. The third coating may also contain aggregate, for example marble. The third coating may also optionally contain water, fillers, defoamers, dispersants, pigments and colorants, and other additives commonly used in insulation coatings.

Exemplary third coatings may be formed from up to about 22% by weight, preferably about 7 to about 14%, water; up to about 5% by weight, preferably up to about 0.2%, potassium tripolyphosphates; up to about 5% by weight, preferably up to about 0.4%, dispersant; up to about 5% by weight, preferably up to about 0.2%, defoamer; up to about 15% by weight, preferably about 6.5 to about 8.5%, filler; up to about 6% by weight, preferably, about 0.5 to about 2.5%, pigment; up to about 5% by weight, preferably about 0.5 to about 2.5%, zinc oxide; up to about 50% by weight, preferably about 15 to about 35%, aqueous acrylic emulsion; up to about 5% by weight, preferably up to about 0.25%, defoamer; up to about 94% by weight, preferably about 30 to about 50%, granular material; up to about 5% by weight, preferably up to about 0.75%, thickening agent; up to about 5% by weight, preferably about 1.5 to about 3.5%, solvent; up to about 5% by weight, preferably up to about 0.3%, acid-containing acrylic emulsion copolymer; and up to about 5% by weight, preferably up to about 0.1%, pH control agent.

Suitable third coatings have the properties summarized in Table 3.

TABLE 3
Properties of Third Coating

| Property | Testing Method | Range |
|---|---|---|
| In-Service Temperature | ASTMD-822 | −20° F. to 200° F. |
| Permeability | ASTME-96-80 | 4.8 perms at 29 mils |
| Mildew Resistance | Mil Std-810 | No Mildew Growth |
| Elongation | ASTMD-412 | 350-400% |
| Tensile Strength | ASTMD-412 | 150-200 psi |
| Viscosity | ASTMD-2393 | 100-104 K.U. |
| Low Temperature | ASTMD-412 | passes 180° bend at |
| Flexibility | | −20° F. |
| Freeze/Thaw | | passes 5 cycles |
| Flash Point | | None |
| Solids by Weight | | 69.9% |
| Solids by Volume | | 60.0% |

Suitable binders for use in the coatings of the invention are latex-based, liquid binders.

A wide range of antimicrobials may be used in the coatings, including broad spectrum antimicrobials, fungicides, mildewcides and preservative compositions. The amount of antimicrobials used in the coating is effective to kill (or inhibit the growth of) microorganisms on the surface of the structure to which the coating is applied.

Suitable fillers include any inert material that can be added to cement, including shale, sand, and calcium carbonate.

The aggregate used in the third coating may include fine particles, medium particles or coarse particles. The aggregate may be formed from marble or other stone.

The following Examples are provided to further teach the invention and are not intended to limit the scope thereof. All parts and percentages are given by weight unless otherwise indicated.

### EXAMPLE 1

### First Coating

A first flexible moisture barrier coating is created by combining 1187 g water, 6 g potassium tripolyphosphates (KTPP), 9 g Nuosept® 95 (a mildewcide/preservative), 13 g Fungitrol® 234 (a fungicide) both manufactured by Degussa of Germany, 8 g Nopcod® NXZ (a defoamer) manufactured by Diamond Henkel and 21 g Tamol® 850 (a dispersant) manufactured by Rohm and Haas Company. Next, 309 g Master TiO2 (a bactericide) and 1814.4 g calcium carbonate filler are added to the above ingredients and the entire mixture is then ground. 129 g zinc oxide (pigment and antifungal) is then slowly added as the grinding is occurring. The grinding is then performed at high speed for about 15 minutes. 1678.32 g latex, 30 g Texanol® (a slow evaporating, water-insoluble coalescing aid for latex paints) manufactured by Eastman Chemical Company, and an additional 8 g Nopco® NXZ (a defoamer) manufactured by Diamond Henkel are then added to the above combination. Next 30 g Natrosol® 250 MXR (thickening agent) manufactured by Hercules Incorporated and 105 g propylene glycol (a solvent) are pre-mixed and then added to the other ingredients. 4 g 28% ammonia (pH control agent) is slowly added while mixing the batch. Lastly, 27 g Polyphase® 600 (a broad-spectrum algicide, fungicide, and mildewcide), 11 g Troysan® 186 (a water soluble liquid organic bactericide), both manufactured by Troy Chemical Corporation and 10 g phthalocyanine blue are added while the entire mixture is being agitated.

### EXAMPLE 2

### Second Coating

A second flexible moisture barrier coating is formed by starting with 2041.2 g Rhoplex® FM-2727 (aqueous acrylic emulsion), manufactured by Rohm and Haas Company. Then 51 g of ⅛ inch polyester fibers, 14 g additional fibers, 7 g Nyad G® (fibrous compound and asbestos replacement) manufactured by NYCO Minerals, Inc. and 8 g Nopco® NXZ manufactured by Diamond Henkel are added slowly while mixing the batch. Then 10 g Lomar D® (cement dispersant) manufactured by Cognis are added and mixed well. 2041.2 g of 40-200 sand (ASTM standard) is then added. Next, 18 g Natrosol® 250 MXR manufactured by Hercules Incorporated and 4 g propylene glycol (solvent) are pre-mixed and added to the other ingredients. The mixture is allowed to disperse for about 10 minutes and then 7 g of 28% ammonia are added. 226 g water, 21 g Polyphase® 600, and 9 g of Troysan® 186, both manufactured by Troy Chemical Corporation, are added and the entire mixture is then well agitated. Lastly, the entire above compound is mixed 1-to-1, by weight, with Portland cement.

### EXAMPLE 3

### Third Coating

A flexible moisture barrier coating is created by combining 664 g water, 7 g potassium tripolyphosphates, 20 g Tamol® 850 manufactured by Rohm and Haas Company, and 9 g Nopco® NXZ manufactured by Diamond Henkel. Next, 211 g Master TiO2 and 443 g calcium carbonate filler and 89 g of Zeolex 98®/Huber 683 (pigments) manufactured by J. M. Huber Corporation are added to the above ingredients and the entire mix is then ground. 89 g zinc oxide (pigment and antifungal) is then slowly added as the grinding is occurring. The grinding is then performed for about 15 minutes. 1451.52 g Rhoplex® 2848 manufactured by Rohm and Haas Company, 42 g Texanol® manufactured by Eastman Chemical Company, 10 g Skane® M-8 HQ (a microbiocide) manufactured by Rohm and Haas Company, 9 g Nopco® NXZ manufactured by Diamond Henkel, and 2494.8 g XO white (marble aggregate) are then added to the above combination. Next 40 g of Natrosol® 250 MXR manufactured by Hercules Incorporated and 124 g propylene glycol are pre-mixed and then added to the other ingredients while mixing. 13 g Acrysol ASE-60 (acid-containing acrylic emulsion copolymer) manufactured by Rohm and Haas Company is added. The mixture is allowed to disperse until a uniform composition is achieved and then 4 g of 28% ammonia are added. 112 g of Water Repellant 1306 (water repellant and beading additive) manufactured by Wacker Silicones Corp., 29 grams of Polyphase® 600, and 12 g of Troysan® 186, both manufactured by Troy Chemical Corporation are added while the entire mixture is agitated.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art (in view of the description herein) without departing from the spirit and scope of the invention.

It is also to be understood that the drawings are not necessarily drawn to scale, but that they are merely conceptual in nature. It is the intention, therefore, to be limited only as indicated by the scope of the claims appended hereto.

What is claimed:

1. An insulation coating system for insulating a structure, said insulation coating system comprising:
(a) a first flexible moisture barrier coating comprising an elastomeric acrylic resin and an antimicrobial, wherein said first coating adheres to a surface of said structure with an insubstantial amount of interfacial voids;
(b) a second flexible moisture barrier coating comprising an acrylic resin, a cement and fibers; and
(c) a third flexible moisture barrier coating comprising an elastomeric acrylic resin, an aggregate, a water repellant and an antimicrobial;
wherein said insulation coating system prevents a substantial amount of moisture from entering said surface.

2. The system of claim 1, wherein said surface is masonry block, concrete, plaster or stucco.

3. The system of claim 1, wherein said first coating is up to about 32 mils thick.

4. The system of claim 1, wherein said cement is Portland Cement.

5. The system of claim 1, wherein said second coating is up to about 0.5 inches (500 mils) thick.

6. The system of claim 1, wherein said third coating further comprises a coloring agent.

7. The system of claim 1, wherein said aggregate comprises marble.

8. The system of claim 1, wherein said aggregate is comprised of fine particles, medium particles or coarse particles.

9. The system of claim 1, wherein said antimicrobial is effective to prevent the growth of a substantial amount of microorganisms.

10. The system of claim 1, wherein said antimicrobial is effective to prevent the growth of a substantial amount of mold/bacteria.

11. The system of claim 1, wherein said system is effective to pass vapors away from said surface.

12. The system of claim 1, wherein said first flexible moisture barrier coating further comprises water, a filler, a defoamer, a binder, a dispersant, a pigment and a colorant.

13. The system of claim 1, wherein said second flexible moisture barrier coating further comprises water, a filler, a defoamer, a binder, a dispersant, a pigment and a colorant.

14. The system of claim 1, wherein said third flexible moisture barrier coating further comprises water, a filler, a defoamer, a binder, a dispersant, a pigment and a colorant.

15. A method for insulating a structure, said method comprising the steps of:
(a) applying a first flexible moisture barrier coating to a surface of said structure, wherein said first coating adheres to said surface with an insubstantial amount of interfacial voids, said first coating comprising an elastomeric acrylic resin and an antimicrobial;
(b) applying a second flexible moisture barrier coating on said first coating, wherein said second coating comprises an acrylic resin, a cement and fibers; and
(c) applying a third flexible moisture barrier coating on said second coating, wherein said third coating comprises an elastomeric acrylic resin, a water repellant, an aggregate and an antimicrobial;
wherein said method is effective to prevent a substantial amount of moisture from entering said surface.

16. The method of claim 15, wherein said method permits the passage of vapors away from said surface.

17. The method of claim 15, wherein said surface comprises one or more of masonry block, concrete, plaster and stucco.

18. The method of claim 15, wherein step (a) further comprises applying the first coating up to about 32 mils thick.

19. The method of claim 15, wherein step (b) further comprises applying the second coating up to about 0.5 inches (500 mils) thick.

20. The method of claim 15, wherein said cement comprises Portland Cement.

21. The method of claim 15, wherein step (c) further comprises applying the third coating up to about 24 mils thick.

22. The method of claim 15, wherein said third coating further comprises a coloring agent.

23. The method of claim 15, wherein said aggregate comprises marble.

24. The method of claim 15, wherein said aggregate comprises fine particles, medium particles or coarse particles.

25. The method of claim 15, wherein said antimicrobial is effective to prevent the growth of a substantial amount of microorganisms.

26. The method of claim 15, wherein said antimicrobial is effective to prevent the growth of a substantial amount of mold or bacteria.
